(19) United States
(12) Patent Application Publication
(10) Pub. No.: US 2026/0014578 A1
(43) Pub. Date: Jan. 15, 2026

(54) PRESSURE SENSING IN A ROTARY SPRINKLER

(71) Applicant: Irrigreen, Inc., Edina, MN (US)

(72) Inventors: Gary Klinefelter, Eden Prairie, MN (US); Eric Heidal, Minnetonka, MN (US)

(21) Appl. No.: 18/875,968

(22) PCT Filed: Jul. 1, 2022
(86) PCT No.: PCT/US2022/035994

§ 371 Date: Dec. 17, 2024

(51) Int. Cl. B05B 12/08; B05B 1/14; B05B 1/30; B05B 3/02; B05B 12/04; B05B 15/74

(52) U.S. Cl. CPC B05B 12/087; B05B 1/14; B05B 1/3026; B05B 3/02; B05B 12/04; B05B 15/74

(57) ABSTRACT

A rotary sprinkler includes a base container, a valve configured to control a water flow through a fluid flow path, a nozzle head configured to discharge the water flow, a pressure sensor configured to sense a pressure in the fluid flow path, and a controller configured to control a position of the valve based on the sensed pressure. The fluid flow path includes a first section downstream from the valve having a first cross-sectional area, and a second section downstream from the first section having a second cross-sectional area. The second cross-sectional area is greater than the first cross-sectional area, and a sensing element of the pressure sensor is configured to sense the pressure within the second section. Machine learning is applied to a set of pressure data to refine a valve position to water distance equation.

### FIELD

Embodiments of the present disclosure relate to rotary sprinklers and, more specifically, to pressure sensing in a rotary sprinkler.

### BACKGROUND

Irrigation sprinklers are known for watering circular patterns or arc segments of a circular pattern. Typical irrigation sprinklers discharge a single rotary water stream that is rotated in a circle around a vertical rotational axis. This water stream is thrown by a sprinkler nozzle mounted in the peripheral sidewall of the nozzle head at an upward angle relative to the horizontal to direct the water a radial distance from the nozzle.

Irrigation systems generally comprise multiple sprinklers within multiple watering zones. Each sprinkler is recessed within the ground and is fed water through underground pipes. An irrigation controller activates a zone by opening a valve that controls the flow of water through the pipes of the zone. The irrigation controller activates the zones sequentially for a predetermined period of time based on zone program instructions.

Irrigation sprinklers currently have several drawbacks. The most significant is that they spray water in circles that are overlapped between sprinklers in order to conform to complex landscape shapes. This causes excess water to be deposited in the areas where these sprinklers overlap. In many systems 50% excess water is used.

Another drawback to conventional irrigation sprinklers is that they use only a few nozzles or nozzle openings. One drawback is that some nozzles spray a fine mist close to the sprinkler which results in water evaporation due to the small droplet size. Another drawback is that some of the nozzles must water a large annular ring around the sprinkler which results in watering that is not uniform across the annular ring (i.e., in a radial direction from the nozzle). As a result, these conventional sprinklers wastewater and are inflexible to landscape variations.

“Smart” rotary sprinklers have been disclosed that include an electronically controlled valve for adjusting the distance water streams are discharged based on the angular position of the nozzles. This allows the sprinkler to water customized zones defined by a varying boundary line. Examples of such systems are disclosed in U.S. Pat. Nos. 10,232,395 and 10,654,062, which are incorporated herein by reference in their entirety.

### SUMMARY

Embodiments of the present disclosure relate to rotary sprinklers. One example of a rotary sprinkler includes a base container having an interior cavity, a fluid flow path extending through the interior cavity, a valve, a nozzle head, a pressure sensor, and a controller. The valve is configured to control a water flow through the fluid flow path in a downstream direction. The nozzle head is supported by the base container and coupled to the fluid flow path downstream from the valve. The nozzle head includes at least one nozzle configured to discharge water received through the fluid flow path as a water stream. The pressure sensor includes a sensing element that is configured to sense a pressure within the fluid flow path at a location that is downstream from the valve. The controller is configured to control a position of the valve element based on the sensed pressure. The fluid flow path includes a first section downstream from the valve having a first cross-sectional area measured in a plane that is perpendicular to the downstream direction, and a second section downstream from the first section having a second cross-sectional area measured in a plane that is perpendicular to the downstream direction. The second cross-sectional area is greater than the first cross-sectional area. The sensing element is configured to sense the pressure within the second section.

Another example of a rotary sprinkler includes a base container having an interior cavity, a fluid flow path extending through the interior cavity, a valve, a nozzle head, a pressure sensor and a controller. The valve includes a valve body and a valve element, the valve element is configured to move relative to the valve body to various positions to control a water flow through the fluid flow path in a downstream direction. The nozzle head is supported by the base container, coupled to the fluid flow path, and includes at least one nozzle configured to discharge water received through the fluid flow path as a water stream. The pressure sensor includes a sensing element that is configured to sense a pressure within the fluid flow path at a location that is at least 2 centimeters downstream from the valve element. The controller is configured to control the position of the valve element based on the sensed pressure.

Yet another example of a rotary sprinkler includes a base container having an interior cavity, a fluid flow path extending through the interior cavity, a valve, a nozzle head, a pressure sensor and a controller. The valve includes a valve body and a valve element, the valve element is configured to move relative to the valve body to various positions to control a water flow through the fluid flow path in a downstream direction. The nozzle head is supported by the base container, coupled to the fluid flow path, and includes at least one nozzle configured to discharge water received through the fluid flow path as a water stream. The pressure sensor includes a sensing element that is configured to sense a pressure within the fluid flow path at a location that is downstream from the valve along the fluid flow path. The controller is configured to control the position of the valve element based on the sensed pressure taken a predefined delay after the position of the valve element is adjusted.

This disclosure, in its various combinations, either in apparatus or method form, may also be characterized by the following listing of items:
1. A rotary sprinkler comprising:
   a base container having an interior cavity;
   a fluid flow path extending through the interior cavity;
   a valve including a valve body and a valve element, the valve element is configured to move relative to the valve body to various positions to control a water flow through the fluid flow path in a downstream direction;
   a nozzle head supported by the base container and coupled to the fluid flow path downstream from the valve, the nozzle head comprising at least one nozzle configured to discharge water received through the fluid flow path as a water stream;
   a pressure sensor comprising a sensing element configured to sense a pressure within the fluid flow path at a location that is downstream from the valve; and
   a controller configured to control the position of the valve element based on the sensed pressure,
   wherein:
      the fluid flow path includes:
         a first section downstream from the valve having a first cross-sectional area measured in a plane that is perpendicular to the downstream direction;
         a second section downstream from the first section having a second cross-sectional area measured in a plane that is perpendicular to the downstream direction; and
         the second cross-sectional area is greater than the first cross-sectional area; and
      the sensing element is configured to sense the pressure within the second section.
2. The rotary sprinkler of claim 1, wherein:
   the second section is defined by an interior wall extending transversely to the downstream direction; and
   the sensing element is configured to sense the pressure at a location that is proximate the interior wall.
3. The rotary sprinkler of claim 2, wherein the interior wall is substantially perpendicular to the downstream direction.
4. The rotary sprinkler of claim 3, wherein:
   the base container includes a top cover through which the fluid flow path extends; and
   a surface of the top cover includes the interior wall of the second section.
5. The rotary sprinkler of claim 4, wherein the pressure sensor comprises:
   a port coupling the sensing element to the pressure; and
   sensor electronics contained in the interior cavity and configured to output a pressure signal to the controller that is indicative of the sensed pressure.
6. The rotary sprinkler of claim 5, wherein the port extends through the top cover.
7. The rotary sprinkler of claim 5, wherein:
   a cylindrical protrusion extends from a top surface of the top cover;
   the fluid flow path extends through the cylindrical protrusion; and
   the port extends through the top cover to an interior side of the cylindrical protrusion.
8. The rotary sprinkler of claim 7, further comprising:
   a pedestal attached to the base container, wherein the nozzle head is received within the pedestal when a water pressure within the fluid flow path is below a threshold water pressure, and the nozzle head extends along a vertical axis outside the pedestal when the water pressure within the fluid flow path exceeds the threshold water pressure; and
   a rotator having a base that receives the cylindrical protrusion, the rotator including a motor contained within the interior cavity and configured to drive rotation of the nozzle head about the vertical axis.
9. The rotary sprinkler of claim 5, wherein the port is is displaced at least 2 centimeters from the valve element along the fluid flow path.
10. The rotary sprinkler of claim 9, wherein the port is displaced at least 3 centimeters from the valve element along the fluid flow path.
11. The rotary sprinkler of claim 9, wherein the valve comprises a ball valve.
12. The rotary sprinkler of claim 1, wherein the controller is configured to sample the sensed pressure a predefined delay after the position of the valve element is adjusted.
13. The rotary sprinkler of claim 12, wherein the predefined delay is more than 100 milliseconds.
14. The rotary sprinkler of claim 13, wherein the controller is configured to control the position of the valve element based on an average of a plurality of the samples of the sensed pressure over a period of time.
15. The rotary sprinkler of claim 14, wherein the period of time is less than 300 milliseconds.
16. The rotary sprinkler of claim 1, wherein the controller is configured to adjust the position of the valve element based on, the sensed pressure, an angular position of the nozzle head relative to the base container and a programmed water stream distance corresponding to the angular position.
17. A rotary sprinkler comprising:
   a base container having an interior cavity;
   a fluid flow path extending through the interior cavity;
   a valve including a valve body and a valve element, the valve element is configured to move relative to the valve body to various positions to control a water flow through the fluid flow path in a downstream direction;
   a nozzle head supported by the base container and coupled to the fluid flow path, the nozzle head comprising at least one nozzle configured to discharge water received through the fluid flow path as a water stream;
   a pressure sensor comprising a sensing element configured to sense a pressure within the fluid flow path at a location that is at least 2 centimeters downstream from the valve element along the fluid flow path; and
   a controller configured to control the position of the valve element based on the sensed pressure.
18. The rotary sprinkler of claim 17, wherein the location of the pressure sensed by the sensing element is displaced at least 3 centimeters from the valve element along the fluid flow path.
19. A rotary sprinkler comprising:
a base container having an interior cavity;
a fluid flow path extending through the interior cavity;
a valve including a valve body and a valve element, the valve element is configured to move relative to the valve body to various positions to control a water flow through the fluid flow path in a downstream direction;
a nozzle head supported by the base container and coupled to the fluid flow path, the nozzle head comprising at least one nozzle configured to discharge water received through the fluid flow path as a water stream;
a pressure sensor comprising a sensing element configured to sense a pressure within the fluid flow path at a location that is downstream from the valve along the fluid flow path; and
a controller configured to control the position of the valve element based on at least one sample of the sensed pressure taken a predefined delay after the position of the valve element is adjusted.
20. The rotary sprinkler of claim 19, wherein the predefined delay is more than 100 milliseconds.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. Specifically, features disclosed herein with respect to one embodiment may be equally applicable to another. Further, this Summary is not intended to be used as an aid in determining the scope of the claimed subject matter. Many other novel advantages, features, and relationships will become apparent as this description proceeds. The figures and the description that follow more particularly exemplify illustrative embodiments.

### BRIEF DESCRIPTION OF THE DRAWINGS

FIG. 1 is a schematic diagram of a rotary sprinkler in accordance with embodiments of the present disclosure.

FIG. 2 is a simplified drawing illustrating exemplary water streams from a rotary sprinkler in accordance with embodiments of the present disclosure.

FIG. 3 is a simplified top view of the rotary sprinkler watering a watering zone, in accordance with embodiments of the present disclosure.

FIG. 3 is a schematic diagram of a nozzle head portion of a rotary sprinkler in accordance with embodiments of the present disclosure.

FIGS. 4 and 5 are perspective views of the rotary sprinkler formed in accordance with embodiments of the present disclosure with a nozzle head in lowered and raised positions, respectively.

FIGS. 6 and 7 are exploded perspective views of components contained within a sprinkler base in accordance with embodiments of the present disclosure.

FIG. 8 is a simplified top view of a cover supporting a sensing element of a pressure sensor, in accordance with embodiments of the present disclosure.

FIG. 9 is an exploded perspective view of the nozzle assembly in accordance with embodiments of the present disclosure.

FIG. 10 is a side cross-sectional view of a set of the nozzles formed in accordance with embodiments of the present disclosure.

### DETAILED DESCRIPTION OF ILLUSTRATIVE EMBODIMENTS

Embodiments of the present disclosure are directed to rotary sprinklers, sprinkler systems and methods. Elements depicted in the drawings having the same or similar reference correspond to the same or similar element.

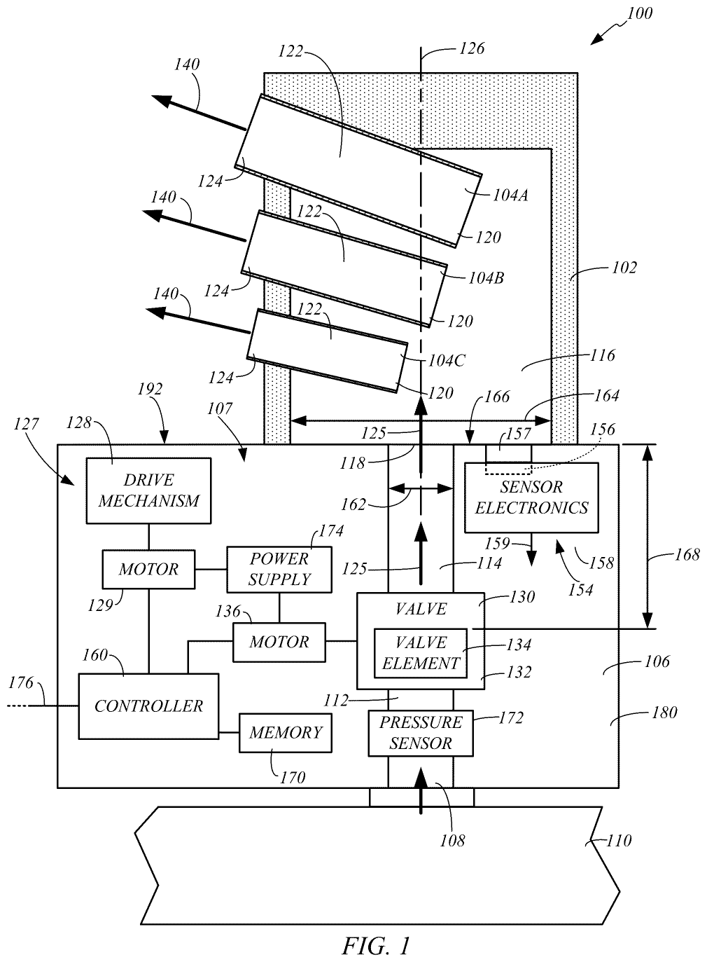

FIG. 1 is a schematic diagram of a rotary sprinkler 100, in accordance with embodiments of the present disclosure. The rotary sprinkler 100 generally comprises a nozzle head 102 that includes at least one nozzle 104. In one embodiment, the nozzle head includes a plurality of nozzles, such as nozzles 104A-C, as shown in FIG. 1. The sprinkler 100 also includes a base container 106 that supports the nozzle head 102, and includes an interior cavity 107 that may contain other components of the sprinkler 100, and protect the components from water and other environmental conditions.

While the exemplary sprinkler 100 is illustrated as including 3 nozzles 104, embodiments of the sprinkler include a single nozzle 104 or two or more nozzles 104. In one embodiment, the sprinkler 100 includes three or more nozzles 104, such as 4-7 nozzles or 8-12 nozzles.

The rotary sprinkler 100 includes a water supply inlet 108 that may be coupled to a water supply line 110, such as a hose or in-ground piping. The water supply line 110 provides a pressurized source of water that is delivered to the nozzles 104 through a fluid flow path 112 of the sprinkler 100, which may be formed by conduit sections and/or openings through components of the sprinkler 100. The fluid flow path 112 comprises a section 114 through the base 106 and a section 116 through the nozzle head 102. The fluid flow path section 114 of the base 106 extends from the water supply inlet 108 to an inlet 118 of the nozzle head 102. The fluid flow path section 116 of the nozzle head 102 extends from the inlet 118 to inlets 120 of the nozzles 104.

Each of the nozzles 104 includes a fluid pathway, generally referred to as 122, that fluidically couples the inlet 120 to an outlet 124. Accordingly, water supplied by the water supply line 110 travels as a water flow in a downstream direction (indicated by arrows 125) and passes through the water supply inlet 108, the fluid flow path section 114 of the base 106, the fluid flow path section 116 of the nozzle head 102 and the fluid pathway 122 of the nozzles 104 where it is discharged through the outlet 124 of the nozzles 104 and directed to the watering area as a water stream.

In one embodiment, the nozzle head 102 is configured to rotate about a vertical axis 126 relative to the base 106. In one embodiment, the rotary sprinkler 100 includes a rotator 127 that includes a drive mechanism 128 that is configured to drive the rotation of the nozzle head 102 about the axis 126 relative to the base 106. The drive mechanism 128 comprises a motor 129, such as an electric motor or a hydraulic motor, that drives the rotation of the nozzle head 102 relative to the base 106, such as through a suitable gear arrangement.

In accordance with one embodiment, the rotary sprinkler 100 is designed for use as an in-ground sprinkler. In one embodiment, the base 106 is buried within the ground and the nozzle head 102 is configured to telescope out of the base 106 to a raised position when a threshold water pressure is applied to at least the inlet 118 of the nozzle head 102 for performance of a watering operation. When the water pressure is removed, the nozzle head 102 recedes within the base 106 to a lowered position, in which it is generally located at or just below the ground surface. In one embodiment, the nozzle head 102 is biased toward the lowered position using, for example, a spring. The spring holds the nozzle head 102 within the base 106 until sufficient water pressure is applied to the inlet 118.

In one embodiment, the rotary sprinkler 100 is configured for above-ground watering operations. In accordance with this embodiment, the base 106 provides sufficient support for the nozzle head 102 such that the nozzle head 102 is maintained in a vertical orientation during the watering operation. Here, it is not necessary for the nozzle head 102 to recede within the base 106.

In one embodiment, the rotary sprinkler 100 includes a valve 130 that controls the flow of water through the fluid flow path 112 (e.g., sections 114 and 116) of the sprinkler 100. Examples of the valve 130 include a ball valve, and other conventional valves.

The valve 130 generally comprises a valve body 132 and a valve element 134 (e.g., ball having a hole for a ball valve), which is configured to move relative to the valve body 132 to various positions that control the water flow through the fluid flow path 112. For example, the valve 130 or valve element 134 has a closed position, in which water is prevented from flowing through the fluid flow path 112, and a fully opened position, in which water is free to travel through the fluid flow path 112 in the downstream direction 125. In one embodiment, the valve 130 also includes intermediary settings or positions that allow the flow rate of the water through the fluid flow path 112 to be set to non-zero values between zero and the maximum flow rate achieved when the valve 130 is in the fully opened position. As a result, the valve 130 may be used to adjust the flow rate of the water through the fluid flow path 112 to a desired level to control the streams discharged by the nozzles 104.

In one embodiment, the position of the valve 130 (e.g., position of the valve element 134 relative to the valve body 132) is controlled by a motor 136. The motor 136 may be a stepper motor, a servo motor, or another suitable motor or device that may be used to adjust the position of the valve 130.

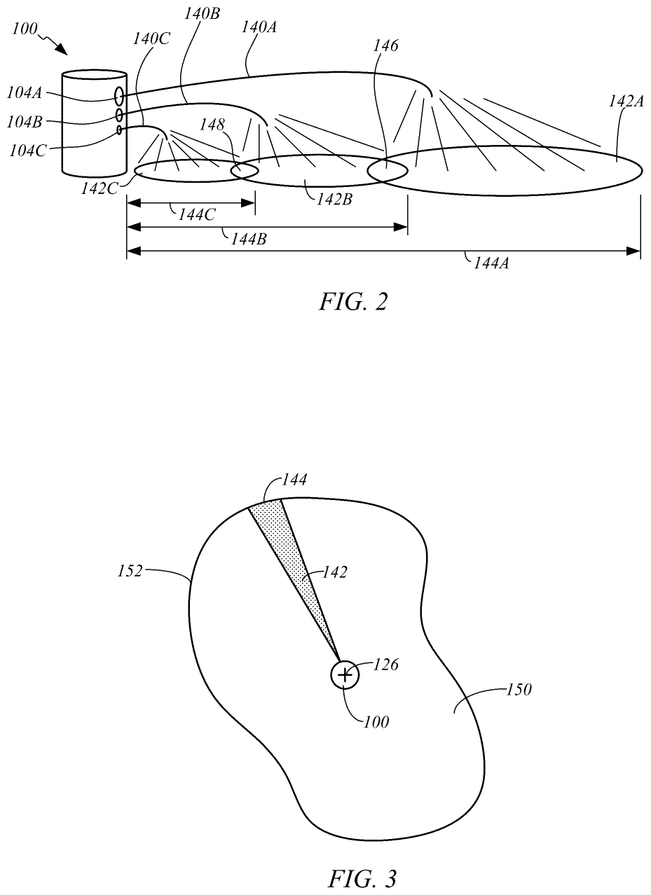

In one embodiment, each of the nozzles 104 is configured to discharge a water stream 140 to a different watering area or target site than the other nozzles 104 of the rotary sprinkler 100. This allows the sprinkler 100 to produce concentric watering rings as the nozzle head 102 is rotated about the vertical axis 126. FIG. 2 is a simplified drawing illustrating exemplary water streams 140 being discharged from the rotary sprinkler 100 in accordance with embodiments of the present disclosure. The water streams 140 fall on watering areas, generally referred to as 142, located on the ground.

In one embodiment, the nozzle 104A is configured to discharge a water stream 140A that falls on a watering area 142A that extends to a radial distance 144A for a given water pressure at the inlet 120 of the nozzle 104A. Nozzle 104B is configured to discharge a water stream 140B to a watering area 142B that extends to a radial distance 144A from the rotary sprinkler 100. Likewise, nozzle 104C is configured to discharge a water stream 140C that falls on a watering area 142C that extends to a radial distance 144C from the sprinkler 100. In one embodiment, the radial distance 144A is greater than the radial distance 144B, which is greater than the radial distance 144C.

In one embodiment, the watering areas 142A, 142B and 142C only partially overlap each other. For instance, the watering area 142A covered by the water stream 140A overlaps only a distal portion 146 of the watering area 142B. Similarly, the watering area 142B of the water stream 140B overlaps only a distal portion 148 of the watering area 142C of the water stream 140C. As a result, each of the water streams 140 produced by the plurality of nozzles 104 of the rotary sprinkler 100 are configured to water an annular ring around the sprinkler 100 as the nozzle head 102 is rotated about the vertical axis 126 relative to the base 106 that does not significantly overlap the annular watering areas covered by the other nozzles 104.

The resultant concentric watering rings allow for uniform watering per unit length in the radial direction from the sprinkler 100 as compared to single nozzle sprinklers. Another advantage is that when the system water flow or pressure is adjusted, a proportional change in the watering pattern occurs.

In one embodiment, the water streams 140 do not produce as much spray as single nozzle sprinklers of the prior art. In one embodiment, the watering areas 142 covered by each of the water streams 140 are approximately elliptical, as illustrated in FIG. 2. This has the advantage of reducing water loss through evaporation into the air, resulting in more efficient watering of the targeted area.

The radial distance the streams 140 travel from the sprinkler 100 depends on various nozzle parameters. These parameters include the diameter of the outlet 124, the length of the fluid pathway 122 and the angle of the nozzle 104 relative to the horizontal plane (i.e., the ground). These parameters of the each of the nozzles 104 may be determined to provide a desired watering pattern for a range of water pressures at the inlet, as generally discussed in the U.S. patents cited above.

The distance the discharged streams 140 travel from the nozzles 104 depends on the water pressure at the inlets 120, which may be adjusted using the valve 130. As a result, by adjusting the valve position based on the angular position of the nozzle head about the axis 126, the sprinkler 100 may water a watering zone 150 having an irregular (e.g., non-circular) radial boundary 152, as illustrated in the simplified top view shown in FIG. 3.

In one embodiment, the rotary sprinkler 100 includes a pressure sensor 154 that measures the pressure of the water in the fluid flow path section 116, which is downstream from the valve 130 relative to the water flow, as indicated by arrows 125. This sensed pressure may be used to determine the distance the longest water stream 140 is traveling, and to control the sprinkler 100 to water a desired zone 50 (FIG. 3).

The pressure sensor 154 may comprise a conventional sensing element 156, which is exposed to the pressure in the fluid flow path section 116 and adjusts a parameter (displacement, resistance, etc.) that is related to the pressure, and conventional sensor electronics 158 configured to output a pressure signal 159 based on the parameter. The pressure signal 159 may be routed to a controller 160 (FIG. 1) of the sprinkler 100, which may be located within the interior cavity 107 of the base container 106 for further processing and use in controlling the sprinkler 100.

In one embodiment, the sensor electronics 158 are contained within the interior cavity 107 of the base container 106. The interior cavity 107 may be sealed to protect the components contained therein from adverse environmental conditions, such as water and dirt, for example.

The sensing element 156 may be a component of the sensor electronics 158 (shown) or formed as a separate component that is electrically connected to the sensor electronics 158. A pressure port 157 (e.g., channel with a flexible diaphragm) may couple the sensing element 156 to the pressure in the fluid flow path section 116 while preventing the interior cavity 107, the sensing element 156 and the sensor electronics 158 from being exposed to the fluid within the section 116.

The water pressure downstream from the valve 130 and at the inlet 120 to the nozzles 104 generally determines the distance 144 the water streams 140 discharged from the nozzles 104 will travel. In order to provide accurate watering of a zone 150, it is important to accurately measure this pressure.

In some embodiments, the sensing element 156 or the port 157 is positioned in the fluid flow path section 116 at a location that is less subject to turbulence in the water flow traveling downstream from the valve 154. This allows for more accurate pressure readings and more accurate watering patterns.

In one embodiment, the fluid flow path section 114 has a cross-sectional area 162 (e.g., opening diameter), and the fluid flow path section 116 has a cross-sectional area 164 (e.g., opening diameter) that is greater than the cross-sectional area 162, as indicated in FIG. 1. The cross-sectional areas 162 and 164 may each be circular or another shape and are each measured in a plane that is perpendicular to the downstream direction 125 of the water flow through the fluid flow path 112.

In one embodiment, the section 116 is partially defined by an interior wall 166 that extends transversely to the downstream direction 125, such as substantially perpendicular (e.g.,) ±10° to the downstream direction 125, as shown in FIG. 1. The sensing element 156 or port 157 may be positioned on the interior wall 166, such that the pressure being sensed is displaced from the fastest flow of water discharged from the fluid flow path section 114 into the section 116. As a result, the pressure being sensed by the sensing element 156 is displaced from the largest pressure fluctuations caused by turbulence in the water flow due to the pressure drop across the valve element 134 and changes in the water flow caused by an adjustment to the position of the valve 130. Accordingly, the sensing element 156 is exposed to a steadier pressure than if the sensing element 156 or port 157 was located in the fluid flow path section 114 located closer to the valve 130. This results in more accurate pressure measurements by the sensor 154 of the pressure within the fluid flow path section 116 and, thus, the pressure at the inlet 120 to the nozzles 104, as compared to when the sensing element 156 is located within the section 114 of the fluid flow path 112 or closer to the valve 130. Additionally, the water pressure being sensed stabilizes more quickly than the water pressure in the fluid flow path section 114 after an adjustment to the valve 130, thereby allowing the sensor 154 to take an accurate pressure measurement very quickly after the position of the valve 130 is adjusted.

In one embodiment, the location of the pressure sensed by the sensing element 156, such as the location of the port 157, is displaced a distance 168 from the valve 130 or valve element 134 to avoid substantial pressure fluctuations caused by turbulence in the water flow, as indicated in FIG. 1. In one example, the distance 168 is at least 2.0 centimeters, at least 2.5 centimeters, at least 3 centimeters, at least 3.5 centimeters, or at least 4.0 centimeters.

The controller 160 represents one or more processors and circuitry used to perform functions described herein. In one embodiment, the processor of the controller 160 is configured to execute program instructions stored in memory 166 (e.g., RAM, ROM, flash memory, or another non-transitory tangible data storage medium) to perform various functions described herein, such as a watering operation.

The controller 160 may take on any suitable form. In one embodiment, the controller 160 represents one or more processors 152 and circuitry that control the components of the sprinkler 100 to perform one or more functions described herein in response to the execution of instructions stored in memory 170. The one or more processors of the controller 150 may be components of computer-based systems, and may include control circuits, microprocessor-based engine control systems, and/or programmable hardware components, such as a field programmable gate array (FPGA). The memory 170 represents local and/or remote memory or computer readable media. Such memory comprises any suitable patent subject matter eligible computer readable media that do not include transitory waves or signals. Examples of suitable forms of the memory 170 include hard disks, CD-ROMs, optical storage devices, and/or magnetic storage devices. The controller 160 may include circuitry for use by the one or more processors to receive input signals, such as the pressure signal 159, issue control signals, such as for controlling the motors 129 and 136, and/or communicate data, such as in response to the execution of the instructions stored in the memory 170.

In some embodiments, a mapping of the position of the valve 130 to the distance 144 of the longest water stream (e.g., distance 144A of stream 140A in FIG. 2) for a range of water pressures at the inlet 108 to the sprinkler 100, is stored in the memory 170 or another location. The pressure at the inlet 108 may be measured using a pressure sensor 172, as shown in FIG. 1. The valve position/distance mapping may be calculated based on parameters of the sprinkler 100, such as the various parameters of the nozzles 104, and/or empirically determined, as generally discussed in the U.S. patents cited above.

In some embodiments, a mapping correlating the pressure sensed by a pressure sensor 154 (e.g., pressure at nozzle inlets 120) to the position of the valve 130 and the distance 144 of the longest water stream 140, may be stored in the memory 170 and used by the controller 160 to control watering operations of the sprinkler 100. Such a mapping may be empirically determined using various techniques.

In one example, the position of the valve 130 is adjusted until the longest water stream 140 reaches an initial predetermined distance 144, such as 6.0 feet, and the pressure sensed by the sensor 154 is recorded along with the valve position and the predetermined distance. The distance 144 is then incremented by a predetermined amount (e.g., 2.0 feet), and the valve position is adjusted until the longest water stream 140 reaches the predetermined distance 144 (e.g., 8.0 feet). The valve position and pressure sensed by the pressure sensor 154 is then recorded for the stream distance 144. These steps are then repeated until the mapping spans a maximum distance 144 (e.g., 30 feet) for the sprinkler 100. One alternative to this technique is to form the mapping by incrementing the position of the valve 130 through various predetermined positions and recording for each valve position the resulting distance 144 of the longest water stream and the pressure sensed by the pressure sensor 154.

After the data has been collected, machine learning may be applied to the data to correlate the position of the valve 130 and the pressure sensed by the pressure sensor 154 to the longest water stream distance 144, and establish a tangential equation (f(x,y)) correlating the valve position or the pressure sensed by the pressure sensor 154 to the longest water stream distance 144 for the sprinkler 100.

In one example of a watering operation, the controller 160 executes watering program instructions stored in the memory 170 or received from a remote system controller, which may include the date and time to commence a watering operation, the duration of the watering operation, a watering pattern, and/or other information. The watering pattern may define the longest water stream distance 144 for each angular position of the nozzle head 102 bout the axis 126, such that the sprinkler 100 waters a desired zone, such as the watering zone 150 shown in FIG. 3.

In one example, the controller 160 obtains a current angular position of the nozzle head 102, which may be a home angular position of the nozzle head 102, and the longest stream distance 140 for the angular position. The controller 160 may then adjust the position of the valve 130 based on a valve setting for achieving the stream distance 144 that is obtained using equation/mapping contained in the memory 170. The controller 160 may increment the angular position of the nozzle head 102 after a predetermined period of time, and repeat the steps described above for the new angular position. This process may continue for the duration of the watering operation.

When the operating water pressure of the sprinkler (e.g., pressure at the inlet 108) remains the same as when the sprinkler was initially installed and calibrated, the sprinkler 100 may accurately water the desired watering zone based on the mapping of the valve position to the longest stream distance. However, changes in water pressure may adversely affect the accuracy of the sprinkler 100. For example, an increase in the water pressure at the inlet 108 may cause too much water flow through the fluid flow path 112 resulting in over-watering the zone 150 and a water stream throw distance 144 that is too long and overshoots the boundary 152 of the zone 150, while a decrease in the water pressure at the inlet 118 may cause too little water flow through the fluid flow path 112 resulting in under-watering of the zone 150 and a water stream throw distance that falls short of the boundary 152.

In one embodiment, the controller 160 may perform a check to determine whether the sprinkler 100 is discharging water to the longest stream distance 144 specified by the watering program instructions using the pressure sensor 154. Here, the initial valve setting for the current angular position acts a “course” setting for the sprinkler 100, and the pressure measured by the pressure sensor 154 is used to finely tune the sprinkler 100 to overcome pressure changes at the inlet 118 such that the longest stream distance 144 substantially matches (e.g., +/−2-6.0 inches) the longest watering distance set by the watering program. Changes in the effective water pressure to the sprinkler 100 (e.g., at the inlet 118) can be detected using the pressure sensor 154 and compensated for using the equation/mapping that correlates the longest stream distance 144 to the pressure sensed by the pressure sensor 154.

For example, after making the “course” adjustment described above, the controller 160 may perform a check to see whether the current pressure sensed by the pressure sensor 154 matches the pressure that was expected for the position of the valve 130 and the longest stream distance setting. If the sensed pressure does not match the expected pressure, the controller 160 may adjust the position of the valve a predetermined amount (e.g., 0.5°) either more open to increase the pressure/water flow rate through the fluid flow path 112 and increase the longest stream distance 144, or more closed to decrease the pressure/water flow rate through the fluid flow path 112 and decrease the longest stream distance 144. The controller 160 may then perform another check on the sensed pressure and make additional adjustments, if necessary, until the sensed pressure substantially matches (e.g., +/−1.0-3.0 psi) the pressure for the desired longest stream distance 144. This ensures that the longest stream distance (e.g., 144A in FIG. 2) output by the sprinkler 100 matches that called for in the watering program instructions.

In one embodiment, the controller 160 is configured to receive control signals from a system controller located remotely from the sprinkler 100 and process the control signals to perform method steps described herein, such as setting the position of the valve 130, rotating the nozzle head 102, communicating information, acknowledging communications, and other functions. The information that may be communicated by the controller includes current operational parameters of the sprinkler 100, such as the pressure sensed by the pressure sensor 154 and indicated by the signal 159, the angular position of the nozzle head 102, the longest stream distance 144, the position of the valve 130, an identification of the watering program being performed, and/or other information. In one embodiment, the controller 160 relays such information to the system controller using either a wired or wireless communication link.

The controller 160 may be configured to sample the pressure signal 159 output by the pressure sensor 154 to improve the accuracy of the pressure reading. For example, after an adjustment to the position of the valve 130 is made by the controller 160, such as using the motor 136, the controller 160 may obtain one or more samples of the pressure signal 159. In one embodiment, the controller 160 obtains a plurality of samples (e.g., 6-10) taken over a period of time (e.g., 100-200 milliseconds), and averages the samples, possibly after eliminating outlier values, to obtain a final pressure measurement. The controller 160 then controls the position of the valve 130 and the longest water stream distance 144 based on the final pressure measurement.

In another embodiment, the controller 160 delays the sampling of the pressure signal 159 for a predetermined period of time after the position of the valve 130 has been adjusted. The delay period is set to allow for the stabilization of the water flow through the valve 130. In some embodiments, the delay period is adjusted based on the degree to which the valve 130 is adjusted. That is, the greater the adjustment to the valve 130, the greater the delay period. This accounts for the additional time required for the water flow to stabilize downstream of the valve 130 after larger adjustments as compared to smaller adjustments. In one example, the delay period is more than 100 milliseconds after the position of the valve 130 has been adjusted, such as 100-500 milliseconds. In some embodiments, the delay period is less than 300 milliseconds.

In one embodiment, the sprinkler 100 includes a power supply 174, such as a battery, a capacitor, a solar cell or other source of electrical energy, that provides power to the processor of the controller 160, the motor 129, the motor 136, the sensor 154, the sensor 172, and/or other components of the sprinkler 100 requiring electrical energy. In one embodiment, the power supply 174 is a rechargeable power supply, which may be recharged by signals received over a control line 176 or another wired connection.

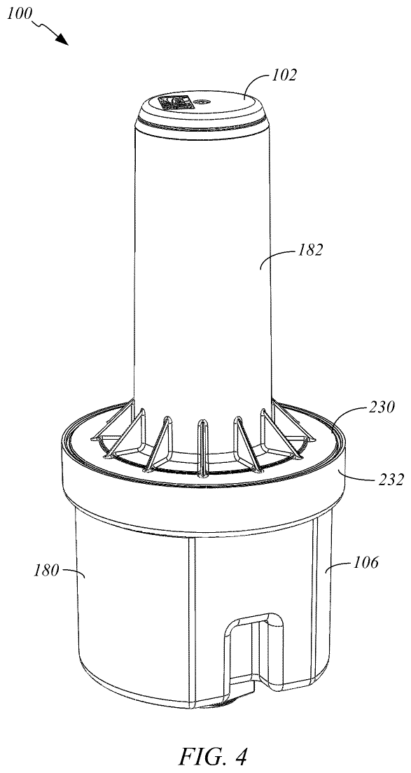

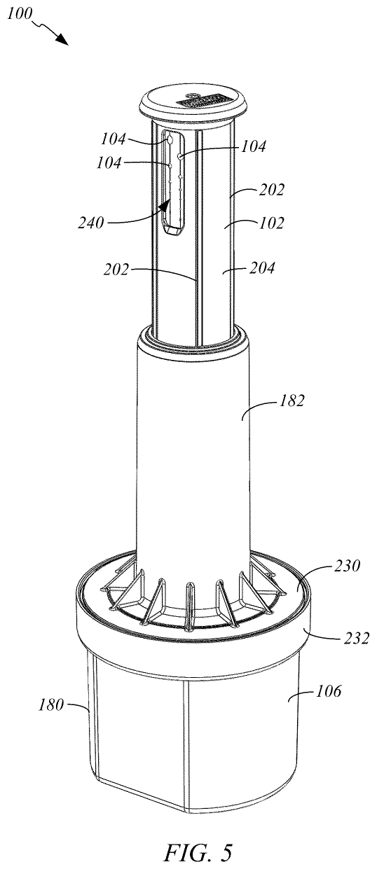

An example of an in-ground version of the rotary sprinkler 100 will be described with reference to FIGS. 4-10. FIGS. 4 and 5 are perspective views of the rotary sprinkler 100 depicting the nozzle head 102 in lowered and raised positions, respectively. In one embodiment, the base 106 comprises a lower or base container 180 and a pedestal 182 that extends above the container 180. The nozzle head 102 is received within the pedestal 182 when in the lowered position (FIG. 4) and extends to the raised position (FIG. 5) in response to water pressure applied to the inlet 118 of the nozzle head 102.

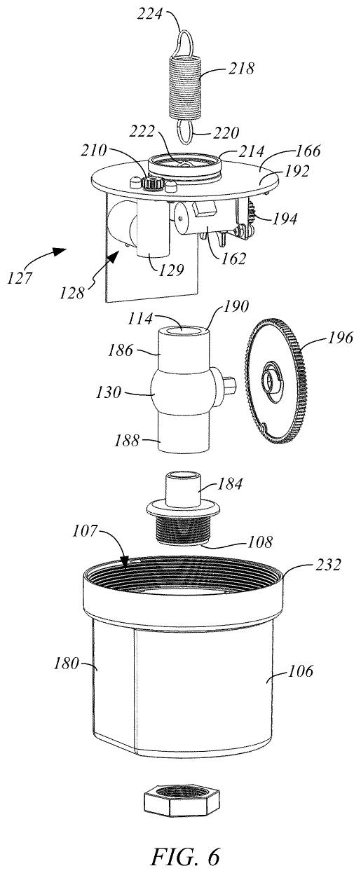

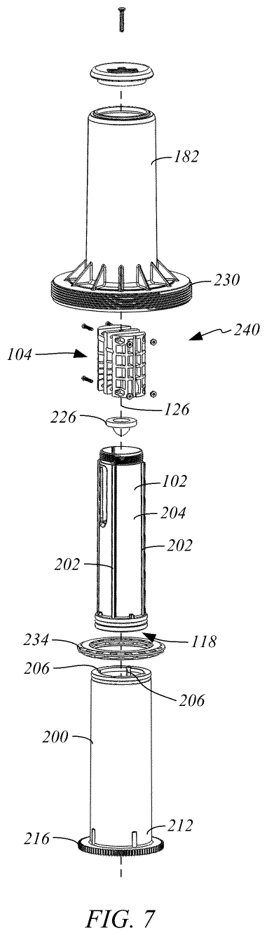

FIG. 6 is an exploded perspective view of the components contained within the base container 180. FIG. 7 is an exploded perspective view of the components contained or supported by the pedestal 182. The fluid flow path 112 extends from a pipe fitting 184 that may be coupled to a water supply line 110 (FIG. 1) and defines the water inlet 108 and through a tubing section 186 having a proximal end 188 that attaches to the pipe fitting 184 and a distal end 190 that extends through a top cover 192, as shown in FIG. 6.

In one embodiment, the tubing section 186 includes the valve 130 that is adapted to control the flow of water through the tubing section 186 of the fluid flow path 112. The motor 136 may drive the valve 130 between the closed, intermediary and fully opened positions through gears 194 and 196, or another suitable arrangement.

In one embodiment, the nozzle head 102 is received within a rotatable support 200, which in turn is received within the pedestal 182. The nozzle head 102 is allowed to telescope out of the rotatable support 200 from the lowered position (FIG. 4) to the raised position (FIG. 5) in response to the application of water pressure at the inlet 118 of the nozzle head 102. In one embodiment, the nozzle head 102 includes protrusions 202 that extend from the exterior surface 204 and are generally aligned with the vertical axis 126. The protrusions 202 are received within vertical slots 206 formed in the interior wall of the rotatable support 200. The engagement of the protrusions 202 of the nozzle head 102 with the slots 206 of the rotatable support 200 causes the nozzle head 102 to rotate along with rotation of the rotatable support 200 about the vertical axis 126.

In one embodiment, the drive mechanism 128 and motor 129 of the rotator 127 may be contained within the interior of the base container 180 (e.g., the components contained in the base 106 of FIG. 1) and may be used to drive rotation of a gear 210 that is supported by the cover 192. A bottom end 212 of the rotatable support 200 receives a cylindrical protrusion 214 extending from a top side of the cover 192 and includes a gear 216. The motor 129 of the drive mechanism 128 rotates the rotatable support 200 about the axis 126 using the gears 210 and 216, which in turn drives the rotation of the nozzle head 102 relative to the pedestal 182 and the container 180.

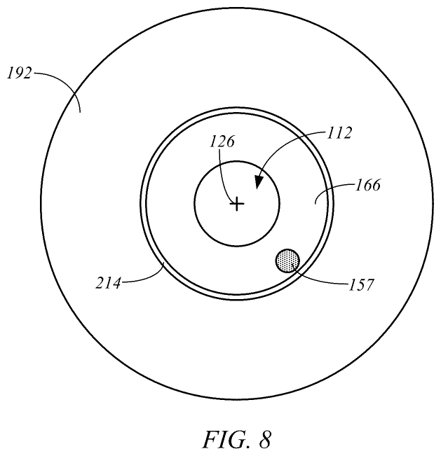

As mentioned above, the pressure sensed by the sensing element 156 of the pressure sensor 154 may be from a location that is downstream from the valve 130 and positioned along or supported by an interior wall 166 that extends transversely to the downstream direction 125 of the fluid flow, as shown in FIG. 1, to reduce the exposure of sensing element 156 to pressures caused by turbulent water flows, and to improve the accuracy of the pressure measurement, as well as the speed at which an accurate measurement may be obtained, such as after an adjustment to the position of the valve 130, for example. In one embodiment, the port 157, which is coupled to the sensing element 156, is supported by the cover 192 of the base container, as shown in FIG. 8, which is a simplified top view of the cover 192 without the gear 210, in accordance with embodiments of the present disclosure. Thus, the top cover 192 may include the interior wall 166 on, or in which, the port 157 is supported. The port 157 may be positioned on an interior side of the cylindrical protrusion 214, as shown in FIG. 8.

As mentioned above, a spring 218 may be used to bias the nozzle head 102 toward the lowered position. Here, a proximal end 220 of the spring 218 is attached to a hook 222 on the cover 192 and a distal end 224 that is attached to a structure supported within the nozzle head 102. The spring 218 maintains the nozzle head 102 in the lowered position when there is insufficient water pressure at the inlet 118 and allows the nozzle head 102 to extend to the raised position under sufficient water pressure at the inlet 118.

In one embodiment, a filter screen 226, shown in FIG. 7, is located within the flow path section 116 to prevent debris from blocking the nozzles 104. Alternatively, the filter screen may be located in the flow path section 114 of the base 106.

In one embodiment, the controller 160 is contained within the base container 180. In one embodiment, the controller 160 operates to control the motor 136 and the positions of the valve 130. In one embodiment, the sprinkler 100 includes a sensor that detects the positions of the valve 130. One exemplary sensor that can be used to carry out this function is a Hall effect sensor that detects a magnetic field of a magnet that is attached to the gear 196, for example.

In one embodiment, the controller 160 controls the motor 129 of the rotator 127 to activate the drive mechanism 128 and rotate the nozzle head 102 about the axis 126. In one embodiment, the sprinkler 100 includes a sensor that detects the angular position of the nozzle head relative to the base 106. One exemplary sensor capable of performing this function is a Hall effect sensor that can detect the magnetic field of a magnet that is attached to the rotatable support 200, the nozzle head 102, or the gear 216 to detect the angular position of the nozzle head 102 relative to the base 106, for example.

In one embodiment, the base container 180 includes the interior cavity 107 within a sealed compartment, in which the electronics of the sprinkler 100 are housed. In one embodiment, the pedestal 182 includes a threaded base 230 which may be screwed on to a threaded opening 232 of the container 180. A seal 234 is positioned between the threaded base 230 and the container 180 to prevent water from entering the compartment containing the electronics.

In one embodiment, a plurality of nozzles 104 are supported by the nozzle head 102. the nozzles 104 may be formed in a nozzle assembly 240. The nozzle assembly 240 is secured to the nozzle head 102 such that the nozzle assembly 240 rotates with rotation of the nozzle head 102.

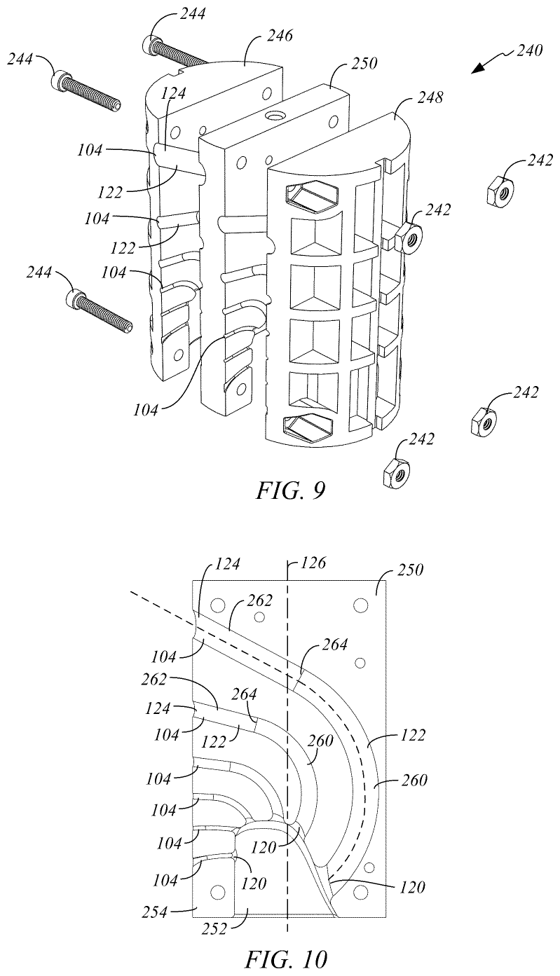

FIG. 9 is an exploded perspective view of the nozzle assembly 240 in accordance with embodiments of the present disclosure. The nozzle assembly 240 may comprise two or more components depending on the number of nozzles 104. Thus, while the illustrated embodiment of the nozzle assembly 240 includes three components that align to form twelve nozzles 104, the nozzle assembly 240 may include two halves that form two or more nozzles 104. In one embodiment, the components forming the nozzle assembly 240 are secured together using nuts 242 and bolts 244. Alternatively, the components forming the nozzle assembly 240 may be connected using an adhesive, by welding the components together, or other suitable technique. Further, the nozzle assembly 240 may also be molded as a single unitary component.

In one embodiment, the nozzle assembly 240 comprises end components 246 and 248 and a central component 250. Each end component 246 and 248 includes one half of the fluid pathways 122 of each of the nozzles 104. The other half of the fluid pathways 122 of the nozzles 104 are formed by the central component 250. When the components 246, 248 and 250 are assembled, each half of the fluid pathway 122 of each nozzle 104 is aligned with its corresponding half fluid pathway 122 to form the full nozzle 104.

FIG. 10 is a side view of the central component 250 of the nozzle assembly 240 and, therefore, a cross-sectional view of one set of the nozzles 104. As shown in FIG. 10, the inlets 120 of each of the nozzles 104 open to a cavity 252 at the base 254 of the nozzle assembly 240. Water received at the inlet 118 of the nozzle head 102 travels through the nozzle head 102 to the cavity 252 where it is provided to inlets 120 of the nozzles 104.

In one embodiment, one or more of the nozzles 104 includes a curved section 260 and a straight section 262. In one embodiment, the curved section 260 extends from the inlet 120 to a location 264 between the inlet 120 and the outlet 124. The straight section 262 extends from the location 264 to the outlet 124.

Although the present disclosure has been described with reference to preferred embodiments, workers skilled in the art will recognize that changes may be made in form and detail without departing from the spirit and scope of the invention.

What is claimed is:

1. A rotary sprinkler comprising:
a base container having an interior cavity;
a fluid flow path extending through the interior cavity;
a valve including a valve body and a valve element, the valve element is configured to move relative to the valve body to various positions to control a water flow through the fluid flow path in a downstream direction;
a nozzle head supported by the base container and coupled to the fluid flow path downstream from the valve, the nozzle head comprising at least one nozzle configured to discharge water received through the fluid flow path as a water stream;
a pressure sensor comprising a sensing element configured to sense a pressure within the fluid flow path at a location that is downstream from the valve; and
a controller configured to control the position of the valve element based on the sensed pressure,
wherein:
the fluid flow path includes:
a first section downstream from the valve having a first cross-sectional area measured in a plane that is perpendicular to the downstream direction;
a second section downstream from the first section having a second cross-sectional area measured in a plane that is perpendicular to the downstream direction; and
the second cross-sectional area is greater than the first cross-sectional area; and
the sensing element is configured to sense the pressure within the second section.

2. The rotary sprinkler of claim 1, wherein:
the second section is defined by an interior wall extending transversely to the downstream direction; and
the sensing element is configured to sense the pressure at a location that is proximate the interior wall.

3. The rotary sprinkler of claim 2, wherein the interior wall is substantially perpendicular to the downstream direction.

4. The rotary sprinkler of claim 3, wherein:
the base container includes a top cover through which the fluid flow path extends; and
a surface of the top cover includes the interior wall of the second section.

5. The rotary sprinkler of claim 4, wherein the pressure sensor comprises:
a port coupling the sensing element to the pressure; and
sensor electronics contained in the interior cavity and configured to output a pressure signal to the controller that is indicative of the sensed pressure.

6. The rotary sprinkler of claim 5, wherein the port extends through the top cover.

7. The rotary sprinkler of claim 5, wherein:
a cylindrical protrusion extends from a top surface of the top cover;
the fluid flow path extends through the cylindrical protrusion; and
the port extends through the top cover to an interior side of the cylindrical protrusion.

8. The rotary sprinkler of claim 7, further comprising:
a pedestal attached to the base container, wherein the nozzle head is received within the pedestal when a water pressure within the fluid flow path is below a threshold water pressure, and the nozzle head extends along a vertical axis outside the pedestal when the water pressure within the fluid flow path exceeds the threshold water pressure; and
a rotator having a base that receives the cylindrical protrusion, the rotator including a motor contained within the interior cavity and configured to drive rotation of the nozzle head about the vertical axis.

9. The rotary sprinkler of claim 5, wherein the port is is displaced at least 2 centimeters from the valve element along the fluid flow path.

10. The rotary sprinkler of claim 9, wherein the port is displaced at least 3 centimeters from the valve element along the fluid flow path.

11. The rotary sprinkler of claim 9, wherein the valve comprises a ball valve.

12. The rotary sprinkler of claim 1, wherein the controller is configured to sample the sensed pressure a predefined delay after the position of the valve element is adjusted.

13. The rotary sprinkler of claim 12, wherein the predefined delay is more than 100 milliseconds.

14. The rotary sprinkler of claim 13, wherein the controller is configured to control the position of the valve element based on an average of a plurality of the samples of the sensed pressure over a period of time.

15. The rotary sprinkler of claim 14, wherein the period of time is less than 300 milliseconds.

16. The rotary sprinkler of claim 1, wherein the controller is configured to adjust the position of the valve element based on, the sensed pressure, an angular position of the nozzle head relative to the base container and a programmed water stream distance corresponding to the angular position.

17. A rotary sprinkler comprising:
a base container having an interior cavity;
a fluid flow path extending through the interior cavity;
a valve including a valve body and a valve element, the valve element is configured to move relative to the valve body to various positions to control a water flow through the fluid flow path in a downstream direction;
a nozzle head supported by the base container and coupled to the fluid flow path, the nozzle head comprising at least one nozzle configured to discharge water received through the fluid flow path as a water stream;
a pressure sensor comprising a sensing element configured to sense a pressure within the fluid flow path at a location that is at least 2 centimeters downstream from the valve element along the fluid flow path; and
a controller configured to control the position of the valve element based on the sensed pressure.

18. The rotary sprinkler of claim 17, wherein the location of the pressure sensed by the sensing element is displaced at least 3 centimeters from the valve element along the fluid flow path.

19. A rotary sprinkler comprising:
a base container having an interior cavity;
a fluid flow path extending through the interior cavity;
a valve including a valve body and a valve element, the valve element is configured to move relative to the valve body to various positions to control a water flow through the fluid flow path in a downstream direction;
a nozzle head supported by the base container and coupled to the fluid flow path, the nozzle head comprising at least one nozzle configured to discharge water received through the fluid flow path as a water stream;
a pressure sensor comprising a sensing element configured to sense a pressure within the fluid flow path at a location that is downstream from the valve along the fluid flow path; and
a controller configured to control the position of the valve element based on at least one sample of the sensed pressure taken a predefined delay after the position of the valve element is adjusted.

20. The rotary sprinkler of claim 19, wherein the predefined delay is more than 100 milliseconds.
